(19) United States
(12) Patent Application Publication
(10) Pub. No.: US 2022/0188008 A1
(43) Pub. Date: Jun. 16, 2022

(54) DATA STORAGE APPARATUS AND OPERATION METHOD THEREOF

(71) Applicant: SK hynix Inc., Gyeonggi-do (KR)

(72) Inventor: Eun Soo JANG, Gyeonggi-do (KR)

(21) Appl. No.: 17/215,276

(22) Filed: Mar. 29, 2021

(30) Foreign Application Priority Data
Dec. 10, 2020 (KR) 10-2020-0172498

(51) Int. Cl. G06F 3/06

(52) U.S. Cl. CPC G06F 3/0647; G06F 3/064; G06F 3/0679; G06F 3/0616; G06F 3/0652

(57) ABSTRACT

A data storage apparatus may include: a storage comprising a plurality of memory blocks in which data are stored; and a controller configured to exchange data with the storage. The controller comprises: a hot block listing component configured to add information on an erased memory block to a hot block list when the erased memory block occurs; a candidate selector configured to select one or more candidate blocks among the plurality of memory blocks based on wear levels of the respective memory blocks; a victim block selector configured to select, as a victim block, at least one block in the hot block list among the candidate blocks; and a wear leveling component configured to perform a wear leveling operation using the victim block.

### CROSS-REFERENCES TO RELATED APPLICATION

The present application claims priority under 35 U.S.C. § 119(a) to Korean application number 10-2020-0172498, filed on Dec. 10, 2020, which is incorporated herein by reference in its entirety.

### BACKGROUND

### 1. Technical Field

Various embodiments generally relate to a semiconductor integrated apparatus, and more particularly, to a data processing apparatus and an operation method thereof.

### 2. Related Art

A data storage apparatus is coupled to a host device, and performs a data input/output operation according to a request of the host device.

The data storage apparatus may use a volatile or nonvolatile memory device as a storage medium.

Among nonvolatile memory devices, a flash memory device needs to perform an erase operation before programming data, and is characterized in that a program unit (i.e., a memory page) thereof is different from an erase unit (i.e., a memory block) thereof.

Since the flash memory device has a limited lifetime, i.e., a limited read/program/erase count, blocks of the flash memory device need to be managed to be uniformly used, in order to prevent the concentration of accesses to a specific block(s).

### SUMMARY

In an embodiment of the present disclosure, a data storage apparatus may include: a storage comprising a plurality of memory blocks in which data are stored; and a controller configured to exchange data with the storage. The controller comprises: a hot block listing component configured to add information on an erased memory block to a hot block list when the erased memory block occurs; a candidate selector configured to select one or more candidate blocks among the plurality of memory blocks based on wear levels of the respective memory blocks; a victim block selector configured to select, as a victim block, at least one block in the hot block list among the candidate blocks; and a wear leveling component configured to perform a wear leveling operation using the victim block.

In an embodiment of the present disclosure, a data storage apparatus may include: a storage comprising a plurality of memory blocks in which data are stored; and a controller configured to exchange data with the storage. As a wear leveling operation is triggered, the controller selects, as a victim block, at least one of the memory blocks whose erase counts satisfy a first condition and whose erase points are close to a wear leveling trigger point, and performs the wear leveling operation.

In an embodiment of the present disclosure, there is provided an operation method of a data storage apparatus which includes a storage comprising a plurality of memory blocks in which data are stored, and a controller configured to exchange data with the storage. The operation method comprising: adding, by the controller, information on an erased memory block to a hot block list when the erased memory block occurs; selecting, by the controller, one or more candidate blocks among the plurality of memory blocks based on wear levels of the respective memory blocks; selecting, by the controller, at least one block in the hot block list, among the candidate blocks, as a victim block; and performing a wear leveling operation using the victim block.

In an embodiment of the present disclosure, a data storage apparatus may include: a storage including a plurality of blocks; and a controller coupled to the storage. The controller is configured to generate a hot block list including one or more hot blocks associated with an erase operation, among the plurality of blocks; select one or more candidate blocks among the plurality of blocks based on wear levels; select, as a victim block, a block in the hot block list among the candidate blocks; and use the victim block to perform a wear levelling operation.

### BRIEF DESCRIPTION OF THE DRAWINGS

FIG. 1 is a configuration diagram illustrating a data storage apparatus in accordance with an embodiment of the present disclosure.

FIG. 2 is a configuration diagram illustrating a controller in accordance with an embodiment of the present disclosure.

FIG. 3 is a configuration diagram illustrating a static wear leveling (SWL) processing component in accordance with the embodiment of the present disclosure.

FIGS. 4A to 4C are conceptual views for describing an operation of a hot block listing component in accordance with an embodiment of the present disclosure.

FIG. 5 is a conceptual view for describing an operation of a victim block selector in accordance with an embodiment of the present disclosure.

FIG. 6 is a flowchart illustrating an operation method of a data storage apparatus in accordance with an embodiment of the present disclosure.

FIG. 7 is a diagram illustrating a data storage system in accordance with an embodiment of the present disclosure.

FIGS. 8 and 9 are diagrams illustrating examples of a data processing system in accordance with embodiments of the present disclosure.

FIG. 10 is a diagram illustrating a network system including a data storage device in accordance with an embodiment of the present disclosure.

FIG. 11 is a block diagram illustrating a nonvolatile memory device included in a data storage device in accordance with an embodiment of the present disclosure.

### DETAILED DESCRIPTION

Hereinafter, a data processing apparatus and an operation method thereof according to the present disclosure will be described below with reference to the accompanying drawings through various embodiments.

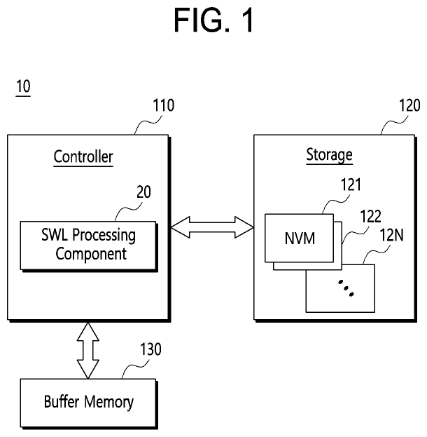

FIG. 1 is a configuration diagram illustrating a data storage apparatus 10 in accordance with an embodiment of the present disclosure.

Referring to FIG. 1, the data storage apparatus 10 may include a controller 110, a storage 120 and a buffer memory 130.

The controller 110 may control the storage 120 in response to a request of a host device (not illustrated). For example, the controller 110 may control the storage 120 to program data thereto according to a write request of the host device. Furthermore, the controller 110 may provide data, written in the storage 120, to the host device in response to a read request of the host device.

The storage 120 may program data thereto or output data programmed therein, under control of the controller 110. The storage 120 may be configured as a volatile or nonvolatile memory device. In an embodiment, the storage 120 may be implemented as a memory device selected among various nonvolatile memory devices such as an electrically erasable and programmable read only memory (ROM) (EEPROM), NAND flash memory, NOR flash memory, phase-change random access memory (RAM) (PRAM), resistive RAM (ReRAM), ferroelectric RAM (FRAM) and spin transfer torque magnetic RAM (STT-MRAM).

The storage 120 may include a plurality of nonvolatile memory devices (NVM) 121 to 12N. Each of the nonvolatile memory devices (NVM) 121 to 12N may include a plurality of dies, a plurality of chips or a plurality of packages. Furthermore, the storage 120 may function as single-level cells each capable of storing 1-bit data therein or extra-level cells each capable of storing multi-bit data therein.

The buffer memory 130 serves as a space capable of temporarily storing data which are transmitted/received when the data storage apparatus 10 performs a series of operations of writing or reading data while interworking with the host device. By way of example, FIG. 1 illustrates the case in which the buffer memory 130 is positioned outside the controller 110. However, the buffer memory 130 may be provided inside the controller 110.

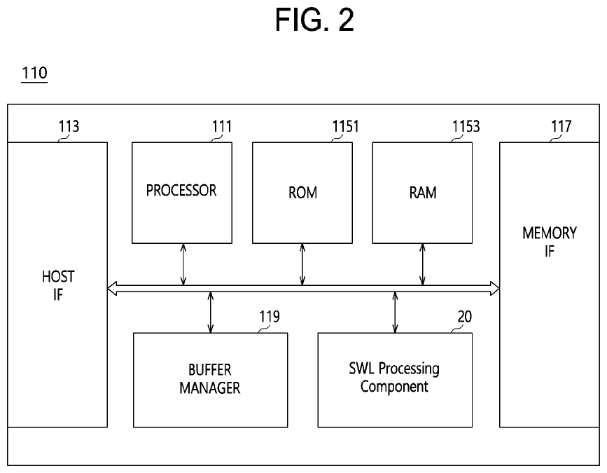

The buffer memory 130 may be controlled by a particular manager, e.g., a buffer manager 119 of FIG. 2.

The buffer manager 119 may divide the buffer memory 130 into a plurality of regions (or slots), and allocate or release the respective regions to temporarily store data. When a region is allocated, it may indicate that data is stored in the corresponding region or data stored in the corresponding region is valid. When a region is released, it may indicate that no data is stored in the corresponding region or data stored in the corresponding region is invalidated.

In an embodiment, the controller 110 may include a static wear leveling (SWL) processing component 20.

Wear leveling refers to a management technique for allowing all memory blocks, constituting the storage 120, to be evenly used. The wear leveling may lengthen the lifetime of the storage 120.

In an implementation, the wear leveling operation may be divided into dynamic wear leveling (DWL) operation and SWL operation.

DWL operation refers to an operation of allocating a free block having the lowest wear level such that the blocks are evenly used when a new program operation is attempted.

SWL operation may refer to an operation which is triggered according to a preset condition, and selects a memory block having the highest or lowest wear level as a victim level and migrates data of the victim block to another block. The SWL operation may be performed as a background operation of the data storage apparatus 10. However, the present embodiment is not limited thereto.

Since the DWL operation is performed only on a free block without considering blocks in use, the SWL operation may be performed in parallel to more evenly manage the wear levels of the memory blocks.

The SWL processing component 20 may manage a hot block list in order of the final erase points of the memory block, which are close to an SWL operation trigger point. Furthermore, the SWL processing component 20 may select, as a victim block, at least one of the blocks included in the hot block list, among candidate blocks whose erase counts are greater than or equal to a predetermined value.

During SWL, cold data may be written to a victim block even though the SWL processing component 20 selected the block having the lowest erase count as the victim block and migrated data of the victim block to another block, or hot data may be written to a victim block even though the SWL processing component 20 selected the block having the highest erase count as the victim block. In this case, an unintended deviation for the erase counts of the respective blocks may occur. In accordance with an embodiment, however, the SWL processing component 20 may select, as a victim block, a block having hot data stored therein among blocks having high erase counts, and migrate data of the victim block, thereby preventing a continuous increase in an erase count for a specific block.

In an embodiment, the SWL processing component 20 may generate and update a hot block list based on an erase point, and select a candidate block based on wear levels. Furthermore, the SWL processing component 20 may randomly select at least one block included in the hot block list among the candidate blocks, and perform wear leveling by using the selected block as a victim block.

In an embodiment, the hot block list is a list in which a designated number of pieces of memory block information are stored in a first-in first-out (FIFO) manner, and the SWL processing component 20 may add a memory block, on which an erase operation has been performed, to the hot block list. That is, when a random block is erased, the SWL processing component 20 may add the random block to the hot block list. At this time, when the hot block list is full, the SWL processing component 20 may remove the block, which was listed for the first time, from the hot block list. In this way, the SWL processing component 20 may manage the hot block list.

In an embodiment, a candidate block may include one or more blocks whose erase counts belong to a preset range. The preset range may correspond to a range of {allowable maximum erase count—α}, where α is a natural number. The preset range may be set by a developer.

That is, the SWL processing component 20 may update the hot block list and the erase count for a memory block whenever an erase operation is performed on the memory block. Furthermore, when SWL is triggered, the SWL processing component 20 may randomly select at least one block included in the hot block list, among candidate blocks whose erase counts belong to the preset range, and use the selected block as a victim block.

In another embodiment, the SWL processing component 20 may randomly select, as a victim block, one or more of blocks whose wear levels, for example, erase counts satisfy a first condition, and whose erase points satisfy a second condition.

The first condition may be determined to be a value which belongs to the range of {allowable maximum erase count—α}, where α is a natural number. The second condition may be determined to be a value within a predetermined time range before the SWL trigger point. From a different point of view, the second condition may be determined to be an erase point which is temporally close to the SWL trigger point.

From a different point of view, the SWL processing component 20 may migrate data of a victim block, whose erase point is close to the SWL trigger point and which has a high wear level, to an empty block.

As such, the SWL processing component 20 may select a hot block having a high wear level as a victim block of SWL, and migrate data of the hot block to another block. Thus, the SWL processing component 20 may stably store hot data in another block, while lowering the frequency of access to the victim block.

Similarly, the SWL processing component 20 may select, as a victim block, at least one of cold blocks whose final erase points are remote from the SWL trigger point, among candidate blocks whose erase counts are less than or equal to a predetermined value.

FIG. 2 is a configuration diagram illustrating the controller 110 in accordance with an embodiment of the present disclosure.

Referring to FIG. 2, the controller 110 may include a processor 111, a host interface (IF) 113, a read only memory (ROM) 1151, a random access memory (RAM) 1153, the buffer manager 119 and a memory interface (IF) 117.

The processor 111 may be configured to transfer various pieces of control information to the host interface 113, the RAM 1153, the buffer manager 119 and the memory interface 117. The various pieces of control information may be information required for a data read or write operation on the storage 120. In an embodiment, the processor 111 may operate according to firmware which is provided for various operations of the data storage apparatus 10. In an embodiment, the processor 111 may perform functions of a flash translation layer (FTL), such as garbage collection, address mapping and wear leveling, to manage the storage 120, or perform a function of detecting and correcting an error of data read from the storage 120.

The host interface 113 may receive a command and clock signal from the host device and provide a communication channel for controlling data input/output, under control of the processor 111. In particular, the host interface 113 may provide a physical connection between the host device and the data storage apparatus 10. Furthermore, the host interface 113 may interface the data storage apparatus 10 in response to a bus format of the host device. The bus format of the host device may include one or more of standard interface protocols such as secure digital (SD), universal serial bus (USB), multi-media card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI Express (PCIe or PCI-e) and universal flash storage (UFS).

The ROM 1151 may store program codes required for an operation of the controller 110, for example, firmware or software, and code data used by the program codes.

The RAM 1153 may store data required for an operation of the controller 110 or data generated by the controller 110.

The memory interface 117 may provide a communication channel for transmitting/receiving signals between the controller 110 and the storage 120. The memory interface 117 may write data, temporarily stored in the buffer memory 130, to the storage 120 under control of the processor 111. Furthermore, the memory interface 117 may transfer data, which is read from the storage 120, to the buffer memory 130 to temporarily store the data.

The buffer manager 119 may be configured to manage the use state of each buffer memory 130. In an embodiment, the buffer manager 119 may divide the buffer memory 130 into a plurality of regions (or slots), and allocate or release the respective regions to temporarily store data.

The SWL processing component 20 may be configured to perform SWL under control of the processor 111.

The SWL processing component 20 may manage, as the hot block list, a preset number of blocks whose final erase points are close to the SWL trigger point. Furthermore, the SWL processing component 20 may select, as a victim block, at least one of blocks included in the hot block list, among candidate blocks whose erase counts are greater than or equal to a predetermined value. Furthermore, the SWL processing component 20 may migrate data of the victim block to another free block, thereby preventing a continuous increase in erase count for a specific block.

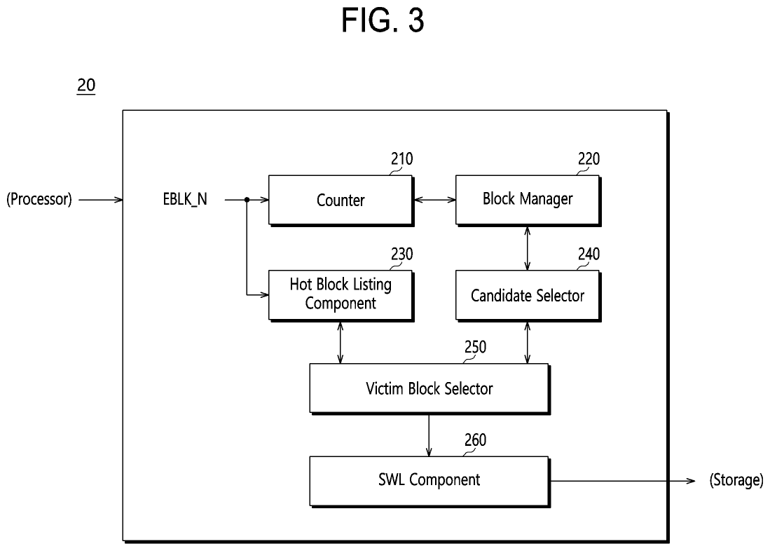

FIG. 3 is a configuration diagram illustrating the SWL processing component 20 in accordance with the embodiment of the present disclosure.

Referring to FIG. 3, the SWL processing component 20 may include a counter 210, a block manager 220, a hot block listing component 230, a candidate selector 240, a victim block selector 250 and a SWL component 260.

As information EBLK_N for an erased block is provided from is the processor 111, the counter 210 may calculate the erase count of the corresponding block, and provide the erase count to the block manager 220.

The block manager 220 may receive the erase count from the counter 210, and update the erase count for each of the memory blocks constituting the storage 120.

The hot block listing component 230 may store a designated number of hot block lists corresponding to a preset depth. In an embodiment, the depth of the hot block list may be obtained by dividing the capacity of the storage 120 by a block size.

As the erased block information EBLK_N is provided from the processor 111, the hot block listing component 230 may add the corresponding block to the hot block list. In an embodiment, the hot block listing component 230 may be a FIFO queue in which the pieces of erased block information EBLK_N provided from the processor 111 are stored in a time-ordered sequence. However, the present embodiment is not limited thereto. Therefore, when a random block is erased, the information of the corresponding block may be added to the hot block list. At this time, when the hot block list is full, the block information which was stored for the first time may be deleted from the hot block list.

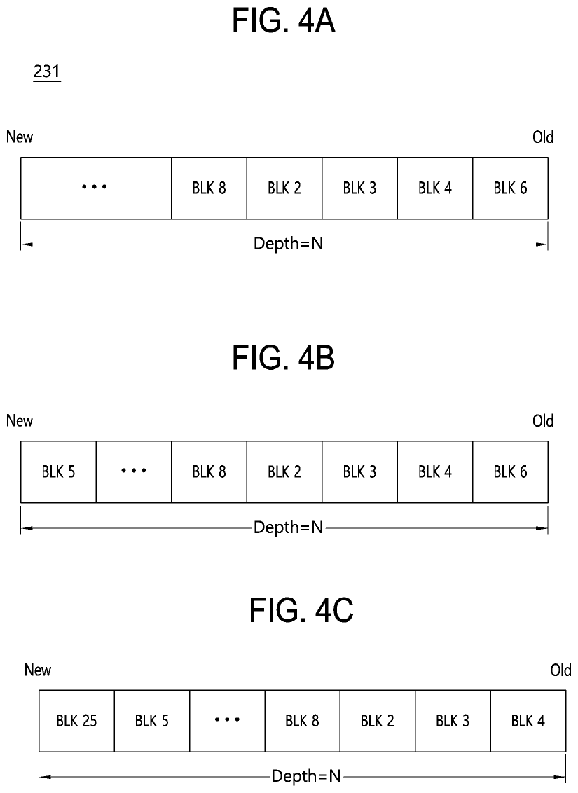

FIGS. 4A to 4C are conceptual views for describing an operation of the hot block listing component 230 in accordance with an embodiment of the present disclosure.

Referring to FIG. 4A, plural pieces of block information BLK6, BLK4, BLK3, BLK2 and BLK8 may be stored in a hot block list 231 having a preset depth of N according to the order in which the blocks are erased. Whenever an erase operation is performed, the hot block list 231 may be updated.

As illustrated in FIG. 4B, the hot block list 231 may become full as the block information BLK5 is added to the hot block list 231.

Then, as new block information BLK25 is added as illustrated in FIG. 4C, the block information BLK6 which was listed for the first time may be removed from the hot block list 231.

Furthermore, block information equal to previously added block information or new block information may be added to the hot block list 231.

The candidate selector 240 may select, as candidate blocks, one or more blocks whose erase counts belong to a preset range, based on the erase counts for the respective blocks, which are managed by the block manager 220. The preset range may correspond to a range of {allowable maximum erase count (Max EC)—α}, where α is a natural number. The preset range may be set by a developer.

The victim block selector 250 may detect blocks included in the hot block list 231 managed by the hot block listing component 230, i.e., hot blocks, among the candidate blocks selected by the candidate selector 240, and select at least one of the detected hot blocks as a victim block. In an embodiment, the victim block selector 250 may randomly select one of the detected blocks. However, the embodiments of the present disclosure are not limited thereto.

The SWL component 260 may migrate data of the victim block, selected by the victim block selector 250, to a target block. The target block may be selected through various methods.

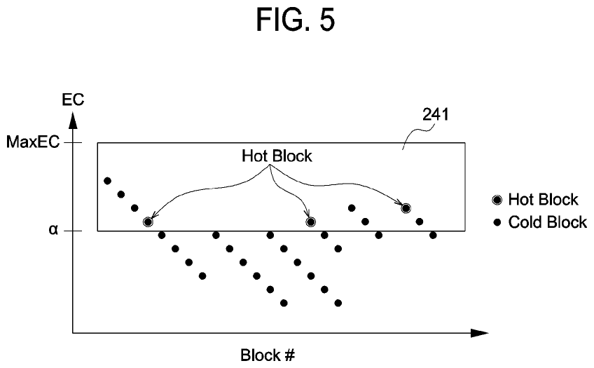

FIG. 5 is a conceptual view for describing an operation of the victim block selector 250 in accordance with an embodiment of the present disclosure.

The candidate selector 240 may select candidate blocks 241 whose erase counts belong to a range of {allowable maximum erase count Max EC—α}, where α is a natural number. The victim block selector 250 may detect hot blocks included in the hot block list 231, among the candidate blocks 241, and randomly select at least one of the hot blocks as a victim block.

Among the candidate blocks 241 whose erase counts belong to the preset range {allowable maximum erase count Max EC—α}, blocks which are not erased at time points close to the SWL trigger point are not selected as victim blocks. Therefore, the SWL processing component 20 may select, as a victim block, a block having hot data stored therein among blocks having high erase counts, and migrate data of the victim block to the target block, thereby preventing a continuous increase in an erase count of a specific block. Since the wear level of a block having cold data stored therein has low variability even though the block has a high erase count, the block may be excluded from the candidates for wear leveling, which makes it possible to prevent unnecessary data migration.

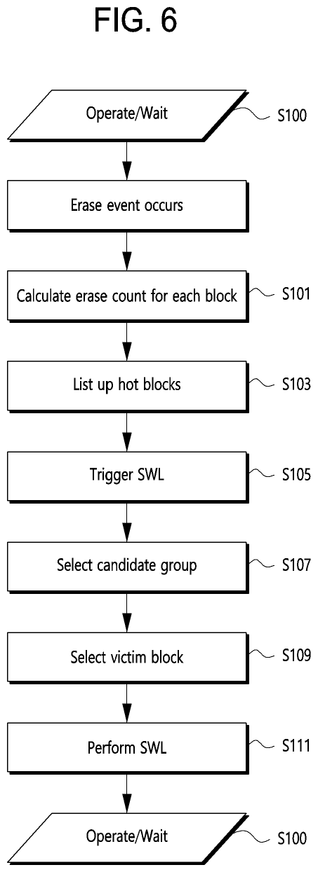

FIG. 6 is a flowchart illustrating an operation method of a data storage apparatus 10 in accordance with an embodiment of the present disclosure.

While the data storage apparatus 10 operates or waits in operation S100, a block erase event may occur.

As information on a block on which an erase operation was performed is provided, the controller 110 may calculate the erase count of the corresponding block in operation S101, and update the erase count of the corresponding memory block.

The controller 110 may add the information on the erased block to the hot block list in operation S103.

SWL may be triggered when a deviation for the erase counts of the memory blocks becomes equal to or more than for example, a preset value.

As the SWL is triggered in operation S105, the controller 110 may select, as candidate blocks, one or more blocks whose erase counts belong to a preset range, based on the erase counts for the respective blocks, in operation S107.

Furthermore, the controller 110 may detect hot blocks, i.e., blocks included in the hot block list, among the candidate blocks selected in operation S107, and select at least one of the detected hot blocks as a victim block in operation S109. In an embodiment, the victim block may be randomly selected. However, the embodiments of the present disclosure are not limited thereto.

Now, the controller 110 may migrate data of the victim block selected in operation S109 to a target block, and perform wear leveling in operation S111.

As such, the controller 110 may select the victim block based on the access patterns and wear levels of the respective memory blocks, and perform wear leveling, thereby improving the operation efficiency of the data storage apparatus.

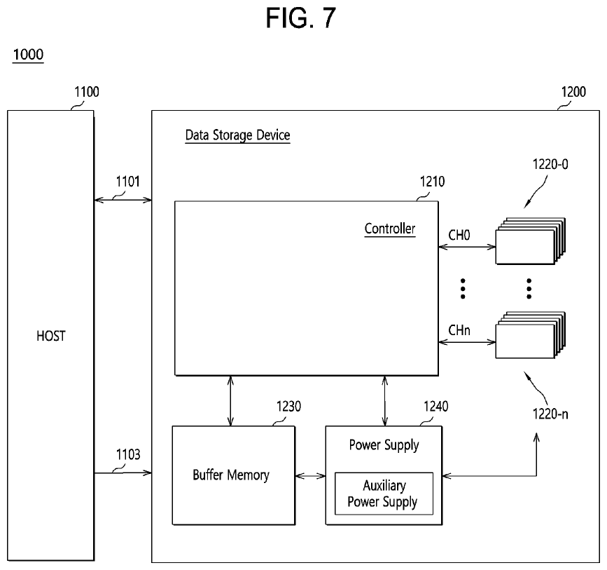

FIG. 7 is a diagram illustrating a data storage system 1000, in accordance with an embodiment of the present disclosure.

Referring to FIG. 7, the data storage system 1000 may include a host device 1100 and a data storage device 1200. In an embodiment, the data storage device 1200 may be configured as a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface unit, a control unit, a random access memory used as a working memory, an error correction code (ECC) unit, and a memory interface unit. In an embodiment, the controller 1210 may be configured as the controller 110 shown in FIGS. 1 to 3.

The host device 1100 may exchange a signal with the data storage device 1200 through the signal connector 1101. The signal may include a command, an address, data, and so forth.

The controller 1210 may analyze and process the signal received from the host device 1100. The controller 1210 may control operations of internal function blocks according to firmware or software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CH0 to CHn, respectively. One or more nonvolatile memory devices may be coupled to one channel. The nonvolatile memory devices coupled to each channel may be coupled to the same signal bus and data bus.

The power supply 1240 may provide power inputted through the power connector 1103 to the controller 1210, the nonvolatile memory devices 1220-0 to 1220-n and the buffer memory device 1230 of the data storage device 1200. The power supply 1240 may include an auxiliary power supply. The auxiliary power supply may supply power to allow the data storage device 1200 to be normally terminated when a sudden power interruption occurs. The auxiliary power supply may include bulk-capacity capacitors sufficient to store the needed charge.

The signal connector 1101 may be configured as one or more of various types of connectors depending on an interface scheme between the host device 1100 and the data storage device 1200.

The power connector 1103 may be configured as one or more of various types of connectors depending on a power supply scheme of the host device 1100.

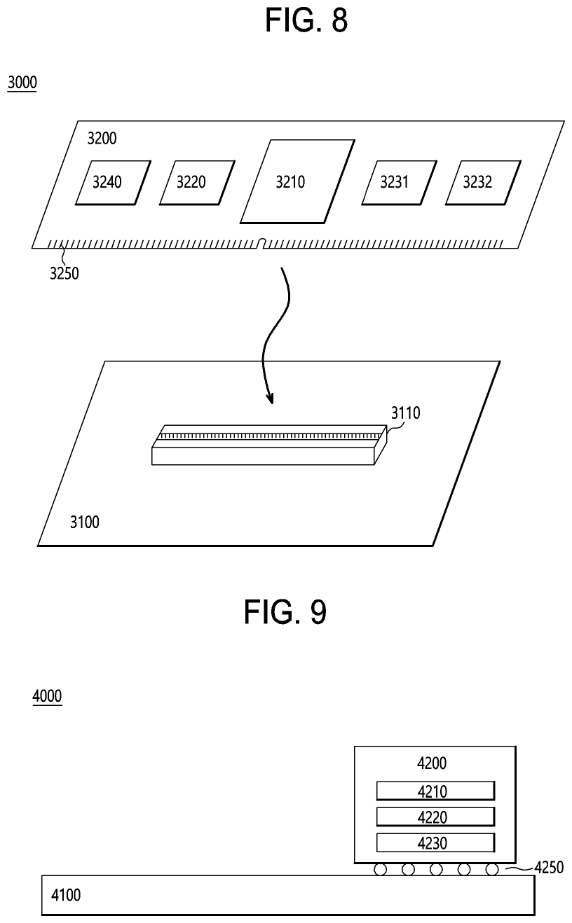

FIG. 8 is a diagram illustrating a data processing system 3000 in accordance with an embodiment of the present disclosure. Referring to FIG. 8, the data processing system 3000 may include a host device 3100 and a memory system 3200.

The host device 3100 may be configured in the form of a board, such as a printed circuit board. Although not shown, the host device 3100 may include internal function blocks for performing the function of a host device.

The host device 3100 may include a connection terminal 3110, such as a socket, a slot, or a connector. The memory system 3200 may be mated to the connection terminal 3110.

The memory system 3200 may be configured in the form of a board, such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 shown in FIGS. 1 to 3.

The buffer memory device 3220 may temporarily store data to be stored in the nonvolatile memory devices 3231 and 3232. Further, the buffer memory device 3220 may temporarily store data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250 to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data, and so forth, and power may be transferred between the host device 3100 and the memory system 3200. The connection terminal 3250 may be configured as one or more of various types depending on an interface scheme between the host device 3100 and the memory system 3200. The connection terminal 3250 may be disposed on a side of the memory system 3200, as shown.

FIG. 9 is a diagram illustrating a data processing system 4000 in accordance with an embodiment of the present disclosure. Referring to FIG. 9, the data processing system 4000 may include a host device 4100 and a memory system 4200.

The host device 4100 may be configured in the form of a board, such as a printed circuit board. Although not shown, the host device 4100 may include internal function blocks for performing the function of a host device.

The memory system 4200 may be configured in the form of a surface-mounted type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 shown in FIGS. 1 to 3.

The buffer memory device 4220 may temporarily store data to be stored in the nonvolatile memory device 4230. Further, the buffer memory device 4220 may temporarily store data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

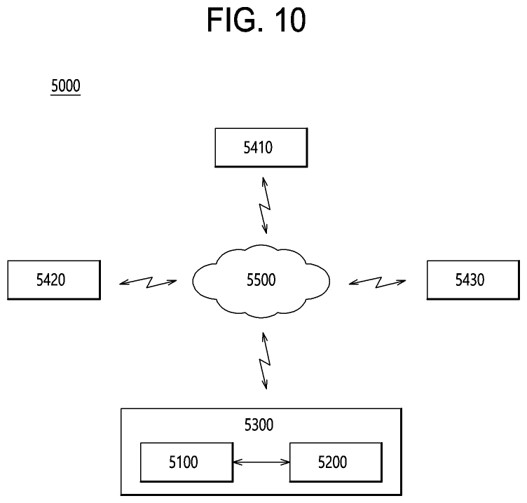

FIG. 10 is a diagram illustrating a network system 5000 including a data storage device in accordance with an embodiment of the present disclosure. Referring to FIG. 10, the network system 5000 may include a server system 5300 and a plurality of client systems 5410, 5420, and 5430, which are coupled through a network 5500.

The server system 5300 may serve data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

The server system 5300 may include a host device 5100 and a memory system 5200. The memory system 5200 may be configured as the data storage apparatus 10 shown in FIG. 1, the data storage device 1200 shown in FIG. 7, the memory system 3200 shown in FIG. 8, or the memory system 4200 shown in FIG. 9.

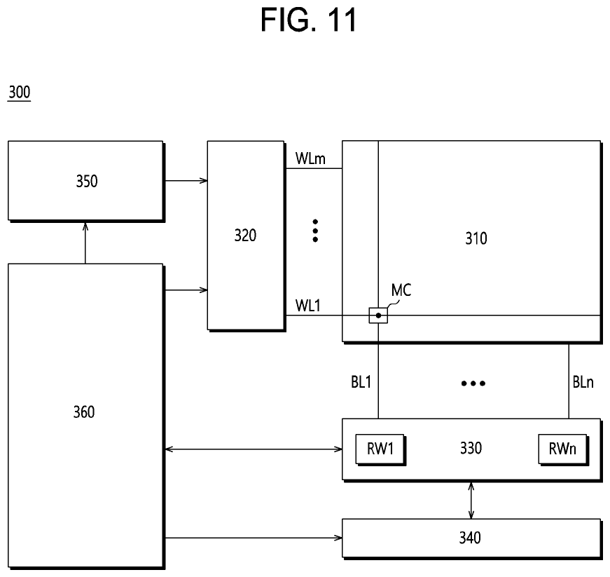

FIG. 11 is a block diagram illustrating a nonvolatile memory device 300 included in a data storage device, such as the data storage apparatus 10, in accordance with an embodiment of the present disclosure. Referring to FIG. 11, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array, for example, has a stacked structure in perpendicular direction to the flat surface of a semiconductor substrate. Moreover, the three-dimensional memory array means a structure including NAND strings having memory cells comprised in the NAND strings, in which the NAND strings are stacked perpendicular to the flat surface of a semiconductor substrate.

The structure of the three-dimensional memory array is not limited to the embodiment indicated above. The memory array structure can be formed in a highly integrated manner with horizontal directionality as well as vertical directionality. In an embodiment, the NAND strings of the three-dimensional memory array memory cells may be arranged in the horizontal and vertical directions with respect to the surface of the semiconductor substrate. The memory cells may be variously spaced to provide different degrees of integration.

The row decoder 320 may be coupled with the memory cell array 310 through the word lines WL1 to WLm. The row decoder 320 may operate according to control of the control logic 360. The row decoder 320 may decode an address provided by an external device (not shown). The row decoder 320 may select and drive the word lines WL1 to WLm, based on a decoding result. For instance, the row decoder 320 may provide a word line voltage, provided by the voltage generator 350, to the word lines WL1 to WLm.

The data read/write block 330 may be coupled with the memory cell array 310 through the bit lines BL1 to BLn. The data read/write block 330 may include read/write circuits RW1 to RWn, respectively, corresponding to the bit lines BL1 to BLn. The data read/write block 330 may operate according to control of the control logic 360. The data read/write block 330 may operate as a write driver or a sense amplifier, according to an operation mode. For example, the data read/write block 330 may operate as a write driver, which stores data provided by the external device in the memory cell array 310 in a write operation. For another example, the data read/write block 330 may operate as a sense amplifier, which reads out data from the memory cell array 310 in a read operation.

The column decoder 340 may operate according to control of the control logic 360. The column decoder 340 may decode an address provided by the external device. The column decoder 340 may couple the read/write circuits RW1 to RWn of the data read/write block 330, respectively corresponding to the bit lines BL1 to BLn, with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided by the external device. For example, the control logic 360 may control operations of the nonvolatile memory device 300 such as read, write, and erase operations.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented in at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

While various embodiments have been described above, it will be understood to those skilled in the art that the embodiments described are examples only. Accordingly, the data storage apparatus and the operation method, which have been described herein, should not be limited based on the described embodiments. It should be understood that many variations and modifications of the basic inventive concept described herein will still fall within the spirit and scope of the present disclosure as defined in the following claims.

What is claimed is:

1. A data storage apparatus comprising:
a storage comprising a plurality of memory blocks in which data are stored; and
a controller configured to exchange data with the storage,
wherein the controller comprises:
a hot block listing component configured to add information on an erased memory block to a hot block list when the erased memory block occurs;
a candidate selector configured to select one or more candidate blocks among the plurality of memory blocks based on wear levels of the respective memory blocks;
a victim block selector configured to select, as a victim block, at least one block in the hot block list among the candidate blocks; and
a wear leveling component configured to perform a wear leveling operation using the victim block.

2. The data storage apparatus of claim 1, wherein the hot block list includes a list in which plural pieces of information on a designated number of memory blocks are stored in a first-input first-output (FIFO) manner according to erase points.

3. The data storage apparatus of claim 1, wherein the controller selects, as the candidate blocks, one or more memory blocks whose erase counts belong to a set range.

4. The data storage apparatus of claim 3, wherein the set range is a range of {allowable maximum erase count—α}, where α is a natural number.

5. The data storage apparatus of claim 1, wherein the controller randomly selects the at least one victim block.

6. A data storage apparatus comprising:
a storage comprising a plurality of memory blocks in which data are stored; and
a controller configured to exchange data with the storage,
wherein as a wear leveling operation is triggered, the controller selects, as a victim block, at least one of the memory blocks whose erase counts satisfy a first condition and whose erase points are close to a wear leveling trigger point, and performs the wear leveling operation.

7. The data storage apparatus of claim 6, wherein the first condition is a range of {allowable maximum erase count—α}, where α is a natural number.

8. The data storage apparatus of claim 6, wherein the controller randomly selects the at least one victim block.

9. An operation method of a data storage apparatus which includes a storage comprising a plurality of memory blocks in which data are stored, and a controller configured to exchange data with the storage, the operation method comprising:
adding, by the controller, information on an erased memory block to a hot block list when the erased memory block occurs;
selecting, by the controller, one or more candidate blocks among the plurality of memory blocks based on wear levels of the respective memory blocks;
selecting, by the controller, at least one block in the hot block list, among the candidate blocks, as a victim block; and
performing a wear leveling operation using the victim block.

10. The operation method of claim 9, wherein the hot block list includes a list in which plural pieces of information on a designated number of memory blocks are stored in a first-input first-output (FIFO) manner according to erase points.

11. The operation method of claim 9, wherein the selecting the one or more candidate blocks comprises selecting one or more memory blocks whose erase counts belong to a set range.

12. The operation method of claim 11, wherein the set range is a range of {allowable maximum erase count—α}, where α is a natural number.

13. The operation method according to claim 9, wherein the selecting the at least one block as the victim block comprises randomly selecting the at least one victim block.

14. A data storage apparatus comprising:
a storage including a plurality of blocks; and
a controller coupled to the storage and configured to:
generate a hot block list including one or more hot blocks associated with an erase operation, among the plurality of blocks;
select one or more candidate blocks among the plurality of blocks based on wear levels;
select, as a victim block, a block in the hot block list among the candidate blocks; and
use the victim block to perform a wear levelling operation.

15. The data storage apparatus of claim 14, wherein the hot block list includes a list in which plural pieces of information on a designated number of memory blocks are stored in a first-input first-output (FIFO) manner according to erase points.

16. The data storage apparatus of claim 14, wherein the controller selects, as the candidate blocks, one or more memory blocks whose erase counts belong to a set range.

17. The data storage apparatus of claim 14, wherein the controller randomly selects the at least one victim block.
